(19) United States
(12) Patent Application Publication
(10) Pub. No.: US 2026/0338302 A1
(43) Pub. Date: Oct. 29, 2026

(54) CONTINUOUS FIBER REINFORCED TAPES

(71) Applicant: Avient Corporation, Avon Lake, OH (US)

(72) Inventors: Daniel FLAGG, Littleton, CO (US); Zachary K. ZANDER, Lake Geneva, WI (US); John SWANSON, Lakewood, OH (US); Benjamin PILPEL, Centennial, CO (US)

(73) Assignee: Avient Corporation, Avon Lake, OH (US)

(21) Appl. No.: 19/486,151

(22) PCT Filed: May 24, 2024
(86) PCT No.: PCT/US2024/030968

§ 371 Date: Nov. 20, 2025

Related U.S. Application Data
(60) Provisional application No. 63/469,046, filed on May 25, 2023.

(51) Int. Cl. F16L 11/10; C08J 5/04; C08J 5/08; C08J 5/10; C08K 3/32; F16L 11/12

(52) U.S. Cl. CPC F16L 11/10; C08J 5/043; C08J 5/08; C08J 5/10; C08K 3/32; F16L 11/12; C08J 2373/00; C08K 2003/325

(57) ABSTRACT

A continuous fiber reinforced tape includes, based on a total weight of the continuous reinforced fiber tape, 20 wt % to 50 wt % of a polyketone component and 50 wt % to 80 wt % of a plurality of unidirectional continuous fibers embedded in the polyketone component.

### CLAIM OF PRIORITY

This application claims the benefit of U.S. Provisional Patent Application Ser. No. 63/469,046 and filed on May 25, 2023, which is hereby incorporated by reference in its entirety.

### TECHNICAL FIELD

Embodiments of the present disclosure are generally related to continuous fiber reinforced tapes, and are specifically related to continuous fiber reinforced tapes including a polyketone component and unidirectional continuous fibers embedded in the polyketone component.

### BACKGROUND

Continuous fiber reinforced tapes may have desirable properties, such as flexibility, for use in fiber reinforced pipes. However, conventional continuous fiber reinforced tapes formed from semi-crystalline thermoplastics or amorphous thermoplastics may not have sufficient shear strength at elevated temperatures (i.e., greater than or equal to 100 °C) and chemical resistance (e.g., oil resistance) desirable for certain applications, such as applications in the oil and gas industry.

Accordingly, a continual need exists for continuous fiber reinforced tapes that have advantageous shear strength at elevated temperatures (i.e., greater than or equal to 100 °C) and chemical resistance.

### SUMMARY

Embodiments of the present disclosure are directed to continuous fiber reinforced tapes.

According to some embodiments, a continuous fiber reinforced tape is provided. The continuous fiber reinforced tape includes, based on a total weight of the continuous fiber reinforced tape, 20 wt % to 50 wt % of a polyketone component and 50 wt % to 80 wt % of a plurality of unidirectional continuous fibers embedded in the polyketone component.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a schematic view of a continuous fiber reinforced tape, according to one or more embodiments described herein;

FIG. 2 is a schematic view of a continuous fiber reinforced tape laminate, according to one or more embodiments described herein;

FIG. 3 is cross-sectional view of a continuous fiber reinforced pipe, according to one or more embodiments described herein;

FIG. 4 is a cross-sectional view of another continuous fiber reinforced pipe, according to one or embodiments described herein;

FIG. 5 is a plot of temperature (x-axis; in °C) versus shear strength (y-axis; in MPa) of comparative CFR tapes and an example CFR tape, according to one or more embodiments described herein;

FIG. 6 is a plot of temperature (x-axis; in °C) versus shear strength retention (y-axis; in percentage (%)) of comparative CFR tapes and an example CFR tape, according to one or more embodiments described herein;

FIG. 7 is a plot of immersion time (x-axis; in hours) versus weight change from dry (y-axis; in percentage (%)) and flexural strength (y-axis; in MPa) of a comparative CFR tape and an example CFR tape, according to one or more embodiments described herein;

FIG. 8 is a scanning electron microscope (SEM) image at 1500× magnification of glass fibers including a polyamide sizing composition, according to one or more embodiments described herein;

FIG. 9 is a SEM image of the glass fibers of FIG. 8 at 500× magnification;

FIG. 10 is a SEM image at 1500× magnification of glass fibers including a polyethylene terephthalate/polybutylene terephthalate sizing composition;

FIG. 11 is a SEM image of the glass fibers of FIG. 10 at 500× magnification;

FIG. 12 is a SEM image at 1500× magnification of glass fibers including a polypropylene sizing composition; and

FIG. 13 is a SEM image of the glass fibers of FIG. 12 at 500× magnification.

### DETAILED DESCRIPTION

Reference will now be made in detail to various embodiments of continuous fiber reinforced (“CFR”) tapes.

The disclosure should not be construed as limited to the embodiments set forth herein. Rather, these embodiments are provided so that this disclosure will be thorough and complete, and will fully convey the subject matter to those skilled in the art.

### DEFINITIONS

Unless otherwise defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it not intended that any method disclosed herein be construed as requiring that its steps be performed in a specific order, nor that any article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value, which encompasses a functionally equivalent range surrounding that numerical value, such that either possibility is contemplated as an embodiment disclosed herein.

As used herein, the term “flexural strength” refers to the maximum flexural stress sustained during testing, as measured according to ASTM D790.

As used herein, the term “flexural modulus” refers to the ratio of stress to strain in flexural deformation, as measured according to ASTM D790.

As used herein, the term “tensile strength” refers to longitudinal tensile stress at break or the maximum stress that a material can withstand while stretching in a longitudinal direction before breaking, as measured according to ASTM D3039.

As used herein, the term “tensile modulus” refers to the tensile chord modulus of elasticity, as measured according to ASTM D3039.

As used herein, the term “tensile elongation” refers to the ratio between increased length and initial length after breakage, as measured according to ASTM D3039.

As used herein, the term “in-plane shear strength” refers to the in-plane shear response of a CFR tape, as measured according to ASTM D3518.

As used herein, the term “interlaminar shear strength” refers to the interlaminar shear strength of parallel fibers within a CFR tape, as measured according to ASTM D2344.

As used herein, the term “retained shear strength” refers to a retention of greater than 65% of an in-plane shear strength of a CFR tape at 100 °C compared to the in-plane shear strength of the same CFR tape at 21 °C.

As used herein, the term “melt flow index” refers to the ease of flow of the melt of polymer, as measured according to ASTM D1238.

As used herein, the term “continuous fibers” refers to a fiber that spans all or substantially all of a dimension of the CFR tape. As used herein, the term “substantially all of a dimension,” refers to greater than 75% of a dimension of the CFR tape.

As used herein, the term “average diameter” refers to an average of the diameters of each of the fibers in the plurality of continuous fibers

As discussed hereinabove, CFR tapes may have desirable properties, such as flexibility, for use in, for example, fiber reinforced pipes. However, conventional continuous fiber reinforced tapes formed from semi-crystalline thermoplastics (e.g., PA6, PA66, PA11, PA12, polyethylene, terephthalate, and polyvinylidene fluoride) or amorphous thermoplastics (e.g., polycarbonate) may not have sufficient shear strength at elevated temperatures (i.e., greater than or equal to 100 °C) and chemical resistance (e.g., oil resistance) desirable for certain applications, such as applications in the oil and gas industry.

Disclosed herein are CFR tapes. Specifically, the CFR tapes disclosed herein include a polyketone component and a plurality of unidirectional continuous fibers embedded in the polyketone component. During formation of the CFR tape, the polyketone component may interact and bond with the unidirectional continuous fibers to bind the fibers together, which may result in retained shear strength at elevated temperatures (i.e., greater than or equal to 100 °C). Moreover, the polyketone component may impart chemical resistance to the CFR tape.

Accordingly, the CFR tapes disclosed herein may be used to make any CFR article that requires retained strength at elevated temperatures and/or chemical resistance. The CFR tapes as disclosed herein are especially useful for making CFR articles for oil and gas applications, such as but not limited to, laminates and fiber reinforced pipes.

The CFR tapes disclosed herein may generally be described as comprising a polyketone matrix and a plurality of unidirectional continuous fibers

### Polyketone Component

As described hereinabove, the CFR tapes comprise a polyketone component within which the plurality of unidirectional continuous fibers is embedded.

The CFR tape may include a minimum amount of polyketone component (e.g., greater than or equal to 20 wt %) to ensure there is an adequate amount of polyketone component to sufficiently coat, interact with, and bind the plurality of unidirectional continuous fibers together to form the CFR tape. The amount of the polyketone component in the CFR tape may be limited (e.g., less than or equal to 50 wt %) to ensure there is sufficient improvement of mechanical properties (e.g., shear strength) in relation to the polyketone component being reinforced. Accordingly, in embodiments, the amount of the polyketone in the CFR tape may be, based on a total weight of the CFR tape, greater than or equal to 20 wt %, greater than or equal to 23 wt %, greater than or equal to 25 wt %, or even greater than or equal to 27 wt %. In embodiments, the amount of the polyketone component in the CFR tape may be, based on a total weight of the CFR tape, less than or equal to 50 wt %, less than or equal to 45 wt %, less than or equal to 40 wt %, less than or equal to 35 wt %, less than or equal to 33 wt %, or even less than or equal to 30 wt %. In embodiments, the amount of the polyketone component in the CFR tape may be, based on a total weight of the CFR tape, from 20 wt % to 50 wt %, from 20 wt % to 45 wt %, from 20 wt % to 40 wt %, from 20 wt % to 35 wt %, from 20 wt % to 33 wt %, from 20 wt % to 30 wt %, from 23 wt % to 50 wt %, from 23 wt % to 45 wt %, from 23 wt % to 40 wt %, from 23 wt % to 35 wt %, from 23 wt % to 33 wt %, from 23 wt % to 30 wt %, from 25 wt % to 50 wt %, from 25 wt % to 45 wt %, from 25 wt % to 40 wt %, from 25 wt % to 35 wt %, from 25 wt % to 33 wt %, from 25 wt % to 30 wt %, from 27 wt % to 50 wt %, from 27 wt % to 45 wt %, from 27 wt % to 40 wt %, from 27 wt % to 35 wt %, from 27 wt % to 33 wt %, or even from 27 wt % to 30 wt %, or any and all subranges formed from any of these endpoints. Without being bound by theory, it is believed that the polyketone component may impart chemical resistance to the CFR tape. For example, the presence of the polyketone component may impart oil resistance to the CFR tape.

In embodiments, the polyketone components may include a polyketone polymer. In embodiments, the polyketone polymer may include a minimum amount polyketone monomer units (e.g. greater than or equal to 50 wt %) to ensure there is an adequate amount of polyketone to interact and bond with the plurality of unidirectional continuous fibers coated with compatible sizing. Without being bound by theory, it is believed that the carbon-oxygen bonds of the polyketone may interact with the sizing on the fibers to form chemical bonds, which may strengthen the connection between the polyketone component and the plurality of unidirectional continuous fibers, thereby providing retained shear strength. In embodiments, the polyketone component may comprise a polyketone polymer comprising greater than or equal to 50 wt % polyketone monomer units, based on the total weight of the polyketone polymer, such as greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, greater than or equal to 95 wt %, or even greater than or equal to 99 wt %.

In embodiments, the polyketone polymer may comprise polypropylene monomer units in an amount less than or equal to 15 wt % based on the total weight of the polyketone polymer to lower the crystallinity and the melting point of the polyketone component, which may improve the processability of the resulting CFR tape. For example, the polyketone polymer may comprise polypropylene monomer units in an amount less than or equal to 14 wt %, less than or equal to 13 wt %, less than or equal to 12 wt %, less than or equal to 11 wt %, less than or equal to 10 wt %, less than or equal to 9 wt %, less than or equal to 8 wt. %, less than or equal to 7 wt %, less than or equal to 6 wt. %, less than or equal to 5 wt. %, less than or equal to 4 wt. %, less than or equal to 3 wt. %, less than or equal to 2 wt. %, or even less than or equal to 1 wt % based on the total weight of the polyketone polymer. In embodiments, the polyketone polymer may not comprise polypropylene monomer units.

Suitable commercial embodiments of the polyketone component are available from Hyosung, such as polyketone polymer grade M330F, M330A, or M930F.

In embodiments, the polyketone polymer may have a melt flow index at 240 °C/2.16 kg, as measured according to ASTM D1238, greater than or equal to 50 g/10 min, such as greater than or equal to 75 g/10 min, greater than or equal to 100 g/10 min, greater than or equal to 125 g/10 min, greater than or equal to 150 g/10 min, greater than or equal to 175 g/10 min, greater than or equal to 200 g/10 min, greater than or equal to 225 g/10 min, greater than or equal to 250 g/10 min, greater than or equal to 275 g/10 min, greater than or equal to 300 g/10 min, greater than or equal to 325 g/10 min, greater than or equal to 350 g/10 min, greater than or equal to 375 g/10 min, or even greater than or equal to 400 g/10 min.

In embodiments, the polyketone component may comprise a heat stabilizer to improve the mechanical properties of the CFR tape at elevated temperatures (e.g., greater than or equal to 100 °C). In embodiments, the heat stabilizer may comprise calcium hydroxyapitate. In embodiments, the polyketone component may comprise calcium hydroxyapitate in an amount from 0.20 wt % to 1.0 wt % based on the total weight of the polyketone component, such as from 0.20 wt % to 0.9 wt %, from 0.2 wt % to 0.8 wt %, from 0.2 wt % to 0.7 wt %, from 0.2 wt % to 0.6 wt %, from 0.2 wt % to 0.5 wt %, from 0.2 wt % to 0.4 wt %, from 0.2 wt % to 0.3 wt %, from 0.3 wt % to 1.0 wt %, from 0.3 wt % to 0.9 wt %, from 0.3 wt % to 0.8 wt %, from 0.3 wt % to 0.7 wt %, from 0.3 wt % to 0.6 wt %, from 0.3 wt % to 0.5 wt %, from 0.3 wt % to 0.4 wt %, from 0.4 wt % to 1.0 wt %, from 0.4 wt % to 0.9 wt %, from 0.4 wt % to 0.8 wt %, from 0.4 wt % to 0.7 wt %, from 0.4 wt % to 0.6 wt %, from 0.4 wt % to 0.5 wt %, from 0.5 wt % to 1.0 wt %, from 0.5 wt % to 0.9 wt %, from 0.5 wt % to 0.8 wt %, from 0.5 wt % to 0.7 wt %, from 0.5 wt % to 0.6 wt %, from 0.6 wt % to 1.0 wt %, from 0.6 wt % to 0.9 wt %, from 0.6 wt % to 0.8 wt %, from 0.6 wt % to 0.7 wt %, from 0.7 wt % to 1.0 wt %, from 0.7 wt % to 0.9 wt %, from 0.7 wt % to 0.8 wt %, from 0.8 wt % to 1.0 wt %, from 0.8 wt % to 0.9 wt %, or even from 0.9 wt % to 1.0 wt %, or any and all subranges formed from any of these endpoints.

Suitable commercial embodiments of the heat stabilizer are available under the EPSOLUTE brand from Budenheim, such as calcium hydroxyapitate grade C13-09.

### Plurality of Continuous Fibers

As described hereinabove, the CFR tapes comprise a plurality of unidirectional continuous fibers embedded within the polyketone component.

The CFR tape may include a minimum amount of the plurality of unidirectional continuous fibers (e.g., greater than or equal to 50 wt %) to ensure there is sufficient improvement of mechanical properties (e.g., shear strength) in relation to the polyketone component being reinforced. The amount of the plurality of continuous fibers in the CFR tape may be limited (e.g., less than or equal to 80 wt %) to ensure there is an adequate amount of polyketone component to sufficiently coat, interact with, and bind the plurality of continuous fibers together to form the CFR tape. Accordingly, in embodiments, the CFR tape may comprise, based on a total weight of the CFR tape, 50 wt % to 80 wt % of the plurality of unidirectional continuous fibers. In embodiments, the amount of the plurality of unidirectional continuous fibers in the CFR tape may be, based on a total weight of the CFR tape, greater than or equal to 50 wt % or even greater than or equal to 60 wt %. In embodiments, the amount of the plurality of unidirectional continuous fibers in the CFR tape may be, based on a total weight of the CFR tape, less than or equal to 80 wt % or even less than or equal to 70 wt %. In embodiments, the amount of the plurality of unidirectional continuous fibers in the CFR tape may be, based on a total weight of the CFR tape, from 50 wt % to 80 wt %, from 50 wt % to 75 wt %, from 50 wt % to 70 wt %, from 50 wt %, to 65 wt %, from 50 wt % to 60 wt %, from 50 wt % to 55 wt %, from 55 wt % to 80 wt %, from 55 wt % to 75 wt %, from 55 wt % to 70 wt %, from 55 wt % to 65 wt %, from 55 wt % to 60 wt %, from 60 wt % to 80 wt %, from 60 wt % to 75 wt %, from 60 wt % to 70 wt %, from 60 wt % to 65 wt %, from 65 wt % to 80 wt %, from 65 wt % to 75 wt %, from 65 wt % to 70 wt %, from 70 wt % to 80 wt %, from 70 wt % to 75 wt %, or even from 75 wt % to 80 wt %, or any and all subranges formed from any of these endpoints.

In embodiments, the plurality of unidirectional continuous fibers may span all or substantially all of a dimension of the CFR tape. For example, in embodiments, the plurality of unidirectional continuous fibers may span all or substantially all of the length of the CFR tape. In embodiments, each of the unidirectional continuous fibers in the plurality of unidirectional continuous fibers may have a length and the lengths of the unidirectional continuous fibers in the plurality of unidirectional continuous fibers may be substantially parallel. For example, in embodiments, the lengths of the unidirectional continuous fibers may extend along and parallel to the length of the CFR tape.

In embodiments, the plurality of unidirectional continuous fibers may comprise at least one of glass fibers, aramid fibers, basalt fibers, and carbon fibers. In one or more embodiments, the plurality of unidirectional continuous fibers may be continuous glass fibers.

In embodiments, the plurality of unidirectional continuous fibers may have an average diameter from 10 μm to 30 μm to ensure a desired shear strength is achieved. In embodiments, the plurality of unidirectional continuous fibers may have an average diameter from 13 μm to 17 μm. In embodiments, the plurality of unidirectional continuous fibers may have an average dimeter greater than or equal to 10 μm, greater than or equal to 13 μm, or even greater than or equal to 15 μm. In embodiments, the plurality of unidirectional continuous fibers may have an average diameter less than or equal to 30 μm, less than or equal to 27 μm, less than or equal to 25 μm, less than or equal to 23 μm, less than or equal to 20 μm, or even less than or equal to 17 μm. In embodiments, the plurality of unidirectional continuous fibers may have an average diameter from 10 μm to 30 μm, from 10 μm to 27 μm, from 10 μm to 25 μm, from 10 μm to 23 μm, from 10 μm to 20 μm, from 10 μm to 17 μm, from 10 μm to 15 μm, from 10 μm to 13 μm, from 13 μm to 30 μm, from 13 μm to 27 μm, from 13 μm to 25 μm, from 13 μm to 23 μm, from 13 μm to 20 μm, from 13 μm to 17 μm, from 13 μm to 15 μm, from 15 μm to 30 μm, from 15 μm to 27 μm, from 15 μm to 25 μm, from 15 μm to 23 μm, from 15 μm to 20 μm, from 15 μm to 17 μm, from 17 μm to 30 μm, from 17 μm to 27 μm, from 17 μm to 25 μm, from 17 μm to 23 μm, from 17 μm to 20 μm, from 20 μm to 30 μm, from 20 μm to 27 μm, from 20 μm to 25 μm, from 20 μm to 23 μm, from 23 μm to 30 μm, from 23 μm to 27 μm, from 23 μm to 25 μm, from 25 μm to 30 μm, from 25 μm to 27 μm, from 27 μm to 30 μm, or any and all subranges formed from any of these endpoints. Without being bound by theory, it is believed that unidirectional continuous fibers with an average diameter of from 10 μm to 30 μm may allow for greater total fiber surface area within the CFR tape, which may improve the bonding between the fiber and the matrix polymer, thereby improving the shear strength of the CFR tape when compared with tapes using continuous unidirectional fibers with an average diameter of greater than 30 μm.

In embodiments, the plurality of unidirectional continuous fibers may have an average linear mass density from 4400 TEX to 276 TEX. In embodiments, the plurality of unidirectional continuous fibers may have an average linear mass density less than or equal to 4400 TEX, less than or equal to 4000 TEX, less than or equal to 3600 TEX, less than or equal to 3200 TEX, less than or equal to 2800 TEX, less than or equal to 2400 TEX, less than or equal to 2000 TEX, or even less than or equal to 1600 TEX. In embodiments, the plurality of unidirectional continuous fibers may have an average linear mass density greater than or equal to 276 TEX, greater than or equal to 400 TEX, greater than or equal to 600 TEX, greater than or equal to 800 TEX, or even greater than or equal to 1000 TEX. In embodiments, the plurality of unidirectional continuous fibers may have an average linear mass density from 4400 TEX to 276 TEX, from 4400 TEX to 400 TEX, from 4400 TEX to 600 TEX, from 4400 TEX to 800 TEX, from 4400 TEX to 1000 TEX, from 4000 TEX to 276 TEX, from 4000 TEX to 400 TEX, from 4000 TEX to 600 TEX, from 4000 TEX to 800 TEX, from 4000 TEX to 1000 TEX, from 3600 TEX to 276 TEX, from 3600 TEX to 400 TEX, from 3600 TEX to 600 TEX, from 3600 TEX to 800 TEX, from 3600 TEX to 1000 TEX, from 3200 TEX to 276 TEX, from 3200 TEX to 400 TEX, from 3200 TEX to 600 TEX, from 3200 TEX to 800 TEX, from 3200 TEX to 1000 TEX, from 2800 TEX to 276 TEX, from 2800 TEX to 400 TEX, from 2800 TEX to 600 TEX, from 2800 TEX to 800 TEX, from 2800 TEX to 1000 TEX, from 2400 TEX to 276 TEX, from 2400 TEX to 400 TEX, from 2400 TEX to 600 TEX, from 2400 TEX to 800 TEX, from 2400 TEX to 1000 TEX, from 2000 TEX to 276 TEX, from 2000 TEX to 400 TEX, from 2000 TEX to 600 TEX, from 2000 TEX to 800 TEX, from 2000 TEX to 1000 TEX, from 1600 TEX to 276 TEX, from 1600 TEX to 400 TEX, from 1600 TEX to 600 TEX, from 1600 TEX to 800 TEX, or even from 1600 TEX to 1000 TEX, or any and all subranges formed from any of these endpoints.

In embodiments, the plurality of unidirectional continuous fibers may be in a tow, yarn, roving, or woven mat.

In one or more embodiments, the plurality of unidirectional continuous fibers may comprise a sizing composition to allow for compatibilization between the polyketone component and the fibers, which may help the plurality of unidirectional continuous fibers interact and bond with the polyketone component, thereby improving the mechanical properties of the CFR tape. In embodiments, the sizing composition may comprise at least one of a film former, lubricant and a coupling agent. In embodiments, the sizing composition may comprise a polyamide.

### CFR Tape

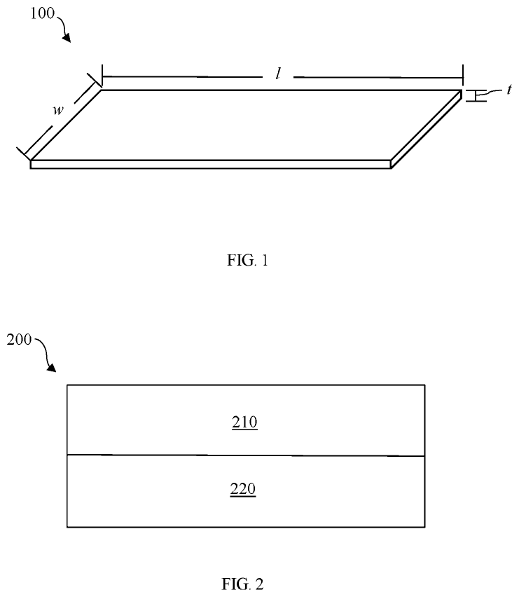

Referring now to FIG. 1, a CFR tape is shown at 100. As described herein, the CFR tape 100 may comprise a polyketone component and a plurality of unidirectional continuous fibers embedded in the polyketone component, which results in a CFR tape with retained shear strength at elevated temperatures and improved chemical resistance.

In embodiments, the CFR tape may retain greater than 65% of its in-plane shear strength at 100 °C. For example, the CFR tape may have a retained shear strength of greater than 70%, greater than 75%, or even greater than 80%.

In embodiments, the CFR tape may have an in-plane shear strength at 21 °C of greater than or equal to 35 MPa, greater than or equal to 36 MPa, or even greater than or equal to 37 MPa. In embodiments, the CFR tape may have an in-plane shear strength at 21 °C of less than or equal to 40 MPa, or even less than or equal to 39 MPa. In embodiments, the CFR tape may have an in-plane shear strength at 21 °C of from 35 MPa to 36 MPa, from 36 MPa to 37 MPa, from 37 MPa to 38 MPa, from 38 MPa to 39 MPa, or even from 39 MPa to 40 MPa, or any and all subranges formed from any of these endpoints.

In embodiments, the CFR tape may have an in-plane shear strength at 100 °C of greater than or equal to 30 MPa, greater than or equal to 31 MPa, or even greater than or equal to 32 MPa. In embodiments, the CFR tape may have an in-plane shear strength at 100 °C of less than or equal to 34 MPa, or even less than or equal to 33 MPa. In embodiments, the CFR tape may have an in-plane shear strength at 100 °C of from 30 MPa to 31 MPa, from 31 MPa to 32 MPa, from 32 MPa to 33 MPa, or even from 33 MPa to 34 MPa, or any and all subranges formed from any of these endpoints.

As described herein, in embodiments, the CFR tape 100 may have a length l, a width w, and a thickness t suitable for its intended application. In embodiments, the thickness t of the CFR tape 100 may be from 0.010 cm to 0.125 cm. For example, the thickness of the CFR tape may be from 0.010 cm to 0.100 cm, from 0.010 cm to 0.075 cm, from 0.010 cm to 0.050 cm, from 0.010 cm to 0.025 cm, from 0.025 cm to 0.125 cm, from 0.025 cm to 0.100 cm, from 0.025 cm to 0.075 cm, from 0.025 to 0.050 cm, from 0.050 cm to 0.125 cm, from 0.050 cm to 0.100 cm, from 0.050 cm to 0.075 cm, from 0.075 cm to 0.125 cm, from 0.075 cm, to 0.100 cm, from 0.100 cm to 0.125 cm, or any and all subranges formed from any of these endpoints.

In embodiments, the CFR tape may have a tensile strength greater than or equal to 650 MPa (94 ksi) or even greater than or equal to 700 MPa (102 ksi). In embodiments, the CFR tape may have a tensile strength less than or equal to 800 MPa (116 ksi) or even less than or equal to 750 MPa (109 ksi). In embodiments, the CFR tape may have a tensile strength from 650 MPa to 800 MPa, from 650 MPa to 750 MPa, from 700 MPa to 800 MPa, or even from 700 MPa to 750 MPa, or any and all subranges formed from any of these endpoints. In embodiments where the continuous unidirectional fibers are carbon fibers, the CFR tape may have a tensile strength of greater than or equal to 1000 MPa, such as greater than or equal to 1250 MPa, or even greater than or equal to 1500 MPa.

In embodiments, the CFR tape may have a tensile modulus greater than or equal to 22000 MPa (3191 ksi) or even greater than or equal to 24000 MPa (3481 ksi). In embodiments, the CFR tape may have a tensile modulus less than or equal to 28000 MPa (4061 ksi) or even less than or equal to 2600 MPa (3771 ksi). In embodiments, the CFR tape may have a tensile modulus from 22000 MPa to 28000 MPa, from 22000 MPa to 26000 MPa, from 24000 MPa to 28000 MPa, or even from 24000 MPa to 26000 MPa, or any and all subranges formed from any of these endpoints. In embodiments where the continuous unidirectional fibers are carbon fibers, the CFR tape may have a tensile modulus of greater than or equal to 50000 MPa, such as greater than or equal to 75000 MPa, or even greater than or equal to 100000 MPa.

In embodiments, the CFR tape may have a tensile elongation greater than or equal to 1% or even greater than or equal to 2%. In embodiments, the CFR tape may have a tensile elongation less than or equal to 10% or even less than or equal to 5%. In embodiments, the CFR tape may have a tensile elongation from 1% to 10%, from 1% to 5%, from 2% to 10%, or even from 2% to 5%, or any and all subranges formed from any of these endpoints.

In embodiments, the CFR tape may have a flexural strength greater than or equal to 300 MPa (43 ksi) or even greater than or equal to 350 MPa (51 ksi). In embodiments, the CFR tape may have a flexural strength less than or equal to 900 MPa (131 ksi) or even less than or equal to 850 MPa (123 ksi). In embodiments, the CFR tape may have a flexural strength from 300 MPa to 900 MPa, from 350 MPa to 850 MPa, from 400 MPa to 800 MPa, from 450 MPa to 750 MPa, from 500 MPa to 700 MPa, from 550 MPa to 650 MPa, from 600 MPa to 650 MPa, or even from 550 MPa to 600 MPa, or any and all subranges formed from any of these endpoints.

In embodiments, the CFR tape may have a flexural modulus greater than or equal to 22000 MPa (3191 ksi) or even greater than or equal to 24000 MPa (3481 ksi). In embodiments, the CFR tape may have a flexural modulus less than or equal to 28000 MPa (4061 ksi) or even less than or equal to 2600 MPa (3771 ksi). In embodiments, the CFR tape may have a flexural modulus from 22000 MPa to 28000 MPa, from 22000 MPa to 26000 MPa, from 24000 MPa to 28000 MPa, or even from 24000 MPa to 26000 MPa, or any and all subranges formed from any of these endpoints.

In certain applications, it may be desirable for the CFR tape to have water absorption resistance. Accordingly, in embodiments, the CFR tape may have percent weight change based on the total weight of the CFR tape after 1000 hrs of water immersion of less than 1.5 wt %. For example, the CFR tape may have a percent weight change based on the total weight of the CFR tape after 1000 hours of water immersion of less than 1.25 wt %, less than 1.0 wt %, less than 0.75 wt %, less than 0.5 wt %, or even less than 0.25 wt %.

### Method of Making

The CFR tapes disclosed herein may be produced by various methods as would be understood by those of ordinary skill in the art. Different form factors of polymer mat be introduced to the continuous fibers as desired and the combination of fibers and polymer can then be processed to make a CFR tape. In embodiments, the CFR tape may be produced in a process where fibers are collected before being introduced to a melted polymer. The fibers may then be impregnated with the melted polymer before being processed to form a CFR tape.

The CFR tapes disclosed herein may be used to make any CFR article that requires retained strength at elevated temperatures and/or chemical resistance. The CFR tapes as disclosed herein are especially useful for making CFR articles for oil and gas applications, such as but not limited to, laminates and fiber reinforced pipes.

Referring now to FIG. 2 a laminate is shown at 200. The laminate 200 may comprise a first layer 210 and a second layer 220. The CFR tape may be the first layer 210 or both the first layer 210 and the second layer 220 in laminate 200. The second layer 220 in laminate 200 may be a layer other than the CFR tape. For example, the second layer 220 in laminate 200 may be a tape with a different composition or a foam layer. In certain embodiments, the second layer 220 in laminate 200 may be foam layer, balsa wood layer, or honeycomb layer. Exemplary foam layers include one or more of polyethylene terephthalate (PET), polyurethane (PU), polyvinyl chloride (PVC), and styrene acrylonitrile (SAN). In certain embodiments, the foam layer may be a foam core that is sandwiched between one or more CFR tape layers on each side. While shown with a first layer 210 and a second layer 220, the laminate 200 may comprise 2-12 layer, 3-11 layers, 4-10 layers, 5-9 layers, or 6-8 layers.

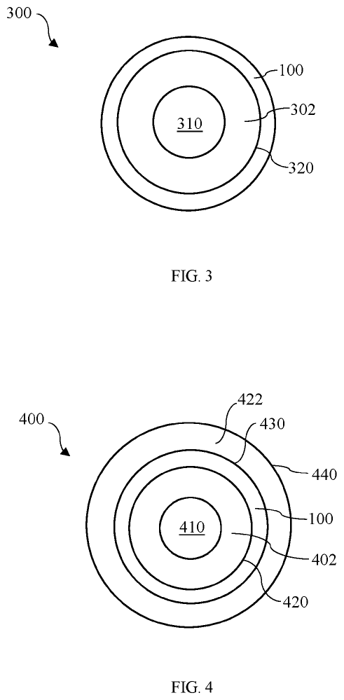

Referring now to FIG. 3, in other embodiments, the CFR tape may be utilized to form a fiber reinforced pipe 300. In embodiments, the fiber reinforced pipe 300 may comprise an interior pipe 302 having an interior cavity 310 and an exterior surface 320 and the CFR tape 100. The CFR tape 100 may be wrapped around the exterior surface 320 of the interior pipe 302. In embodiments, the CFR tape may be helically wrapped around the exterior surface 320 of the pipe 302. In embodiments, the CFR tape may completely cover the exterior surface 320 of the pipe 302. In embodiments, the interior pipe 302 may comprise one or more of high density polyethylene, polyamide, or polyvinylidene fluoride.

Referring now to FIG. 4, in embodiments, a fiber reinforced pipe 400 may comprise an interior cylinder liner 402 having an interior cavity 410 and an exterior surface 420. The fiber reinforced pipe 400 may also comprise an exterior cylinder jacket 422 having an interior cavity 430 and an exterior surface 440. The fiber reinforced pipe 400 may also comprise the CFR tape 100. The CFR tape 100 may be positioned between the interior cylindrical liner 402 and the exterior cylindrical jacket 422 and within the interior cavity 430 of the exterior cylindrical jacket 422. The CFR tape 100 may be helically wrapped. In embodiments, the interior cylinder liner 402 may comprise one or more of high density polyethylene, polyamide, or polyvinylidene fluoride.

In embodiments, the fiber reinforced pipe may be flexible, as measured in accordance with ASTM F2686-14 standard specification for glass fiber reinforced thermoplastic pipe.

In embodiments, the CFR tape of the fiber reinforced pipe may be a first CFR tape and the fiber reinforced pipe may comprise a second CFR tape helically wrapped around the first CFR tape. In embodiments, the second CFR tape may be helically wrapped in the opposite direction of the first wrapped CFR tape.

In embodiments, the fiber reinforced pipe may include from 2 to 12 wraps of the CFR tape. As used herein the term “wrap,” refers to a layer of the CFR tape wrapped once around the circumference of the exterior surface of the pipe, such as from 2 to 11 wraps of the CFR tape, from 2 to 10 wraps, from 2 to 9 wraps, from 2 to 8 wraps, from 2 to 7 wraps, from 2 to 6 wraps, from 2 to 5 wraps, from 2 to 4 wraps, from 2 to 3 wraps, from 3 to 12 wraps, from 3 to 11 wraps, from 3 to 10 wraps, from 3 to 9 wraps, from 3 to 8 wraps, from 3 to 7 wraps, from 3 to 6 wraps, from 3 to 5 wraps, from 3 to 4 wraps, from 4 to 12 wraps, from 4 to 11 wraps, from 4 to 10 wraps, from 4 to 9 wraps, from 4 to 8 wraps, from 4 to 7 wraps, from 4 to 6 wraps, from 4 to 5 wraps, from 5 to 12 wraps, from 5 to 11 wraps, from 5 to 10 wraps, from 5 to 9 wraps, from 5 to 8 wraps, from 5 to 7 wraps, from 5 to 6 wraps, from 6 to 12 wraps, from 6 to 11 wraps, from 6 to 10 wraps, from 6 to 9 wraps, from 6 to 8 wraps, from 6 to 7 wraps, from 7 to 12 wraps, from 7 to 11 wraps, from 7 to 10 wraps, from 7 to 9 wraps, from 7 to 8 wraps, from 8 to 12 wraps, from 8 to 11 wraps, from 8 to 10 wraps, from 8 to 9 wraps, from 9 to 12 wraps, from 9 to 11 wraps, from 9 to 10 wraps, from 10 to 12 wraps, from 10 to 11 wraps, from 11 to 12 wraps, any and all subranges formed from any of these endpoints.

### EXAMPLES

Table 1 below shows sources of ingredients used to form Comparative Tapes C1 and C2 and Example Tapes E1 and E2.

TABLE 1

| Ingredients | Brand | Source |
|---|---|---|
| polyketone polymer | M330A | Hyosung |
| (polyketone component) | | |
| glass fiber | NEG 4515 | Nippon Electric Glass |
| (unidirectional continuous | | |
| fibers) | | |
| calcium hydroxyapitate | EPSOLUTE C13-09 | Budenheim |
| (heat stabilizer) | | |
| nylon | BASF 8202 | BASF |
| polyethylene | DMDA-8940 | DOW |

Table 2 below shows the formulations (in wt %, based on total weight of the CFR tape) and mechanical properties of Example Tapes E1 and E2 and Comparative Tapes C1 and C2. The CFR tapes of the present examples were made by first impregnating the fibers with the polymer matrix before processing the combined fibers and polymer matrix into the CFR tape.

TABLE 2

| Examples | C1 | C2 |
|---|---|---|
| NEG 4515 | 58.0 | 66.0 |
| BASF 8202 | 42.0 | — |
| DMDA-8940 | — | 34.0 |
| Total | 100.0 | — |
| Areal Weight (sqft) | 0.0797 | 0.097 |
| Tensile Strength | 744.6 | 882.5 |
| (MPa and ksi) | (108) | (128) |
| Tensile Modulus | 27372 | 33094 |
| (MPa and ksi) | (3970) | (4800) |
| Tensile Elongation (%) | 2.82 | 2.94 |
| Flexural Strength | 717.1 | 379.2 |
| (MPa and ksi) | (104) | (55) |
| Flexural Modulus | 24959 | 27579 |
| (MPa and ksi) | (3620) | (4000) |
| Example | E1 | E2 |
| M330A | 40.6 | 41.1 |
| NEG 4515 | 59.4 | 58.4 |
| EPSOLUTE C13-09 | — | 0.5 |
| Total | 100.0 | 100.0 |
| Areal Weight (sqft) | 0.0945 | 0.0959 |
| Tensile Strength | 772.2 | 696.4 |
| (MPa and ksi) | (112) | (101) |
| Tensile Modulus | 26269 | 25855 |
| (MPa and ksi) | (3810) | (3750) |
| Tensile Elongation (%) | 3.09 | 2.82 |
| Flexural Strength | 582.6 | 605.4 |
| (MPa and ksi) | (84.5) | (87.8) |
| Flexural Modulus (MPa | 24959 | 25717 |
| and ksi) | (3520) | (3730) |

Table 3 below shows further mechanical properties of Example Tape E2 at various temperatures.

TABLE 3

| | Temp | Strength/Modulus | | |
|---|---|---|---|---|
| Test | (°C) | (MPa and ksi) | | Retention (%) |
| In-plane shear | 21 | 38.6 | (5.6) | 100.00 |
| strength | 85 | 35.0 | (5.07) | 90.54 |
| | 100 | 32.5 | (4.71) | 84.11 |
| Tensile strength | 21 | 675.7 | (98) | 100.00 |
| | 85 | 661.9 | (96) | 97.96 |
| | 100 | 696.4 | (101) | 103.06 |
| Interlaminar | 21 | 43.02 | (6.24) | 100.00 |
| shear strength | 85 | 32.7 | (4.74) | 75.96 |
| | 100 | 31.3 | (4.54) | 72.76 |
| Flexural | 21 | 582.6 | (84.5) | 100.00 |
| strength | 85 | 393 | (57) | 67.46 |
| | 100 | 372.3 | (54) | 63.91 |
| Flexural | 21 | 24269 | (3520) | 100.00 |
| modulus | 85 | 22339 | (3240) | 92.05 |
| | 100 | 23786 | (3450) | 98.01 |

As shown in Table 3, Example Tape E2, a CFR tape including a polyketone component and a plurality of unidirectional continuous fibers, retained greater than 84% of its in-plane shear strength at 100 °C as compared to its in-plane shear strength at 21 °C. As exemplified by Table 3, the CFR tapes disclosed herein including a polyketone component have retained shear strength at elevated temperatures.

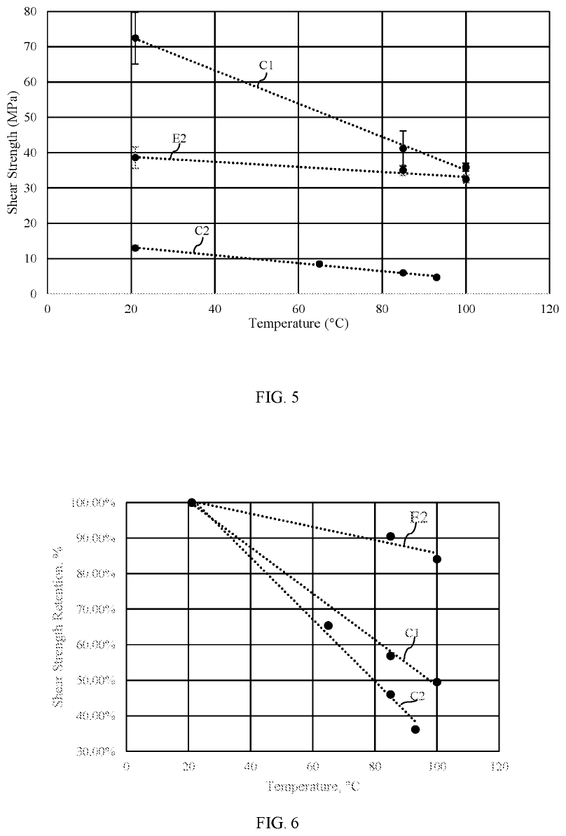

Referring now to FIGS. 5 and 6, Example Tape E2, a CFR tape including a polyketone component, had a better retention of in-plane shear strength at elevated temperatures as compared to Comparative Tapes C1 and C2, CFR tapes lacking a polyketone component. At 100 °C, both of the comparative tapes had less than 60% retention of in-plane shear strength. By comparison, Example Tape E2 had over 80% retention of in-plane shear strength at 100 °C. As exemplified by FIGS. 5 and 6, the CFR tapes disclosed herein including a polyketone component have retained shear strength at elevated temperatures.

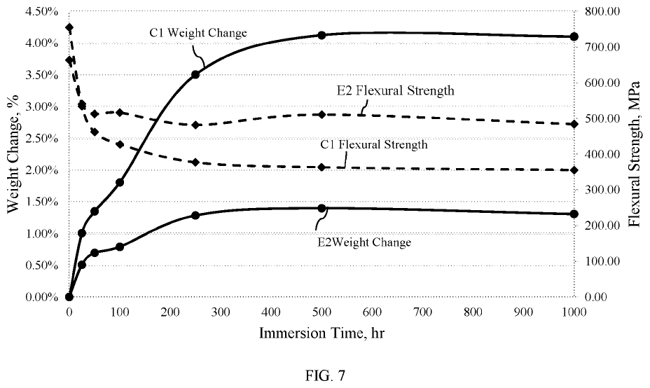

Referring now to FIG. 7, Example Tape E2, after 1000 hours of water immersion, had less than a 1.5% change in weight from dry, while Comparative Tape C1 had a greater than 4.0% change in weight from dry. Furthermore, Example Tape E2 had a smaller decrease in flexural strength as compared to Comparative Composition C1. As exemplified by FIG. 7, the CFR tapes disclosed herein have a relatively lower rate of water absorption and higher retention of flexural strength.

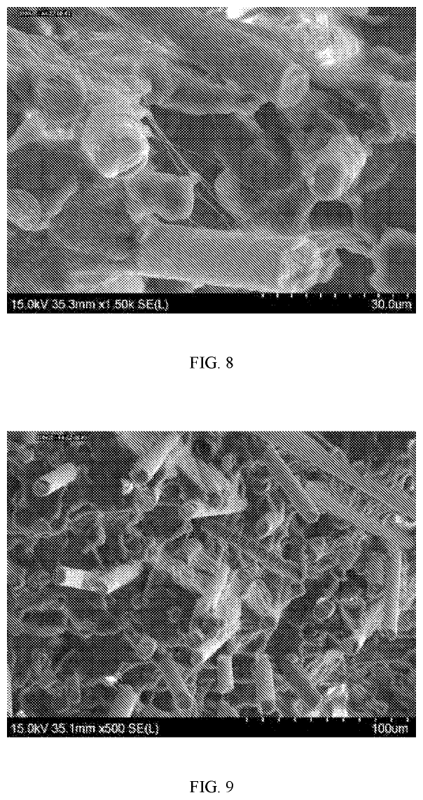

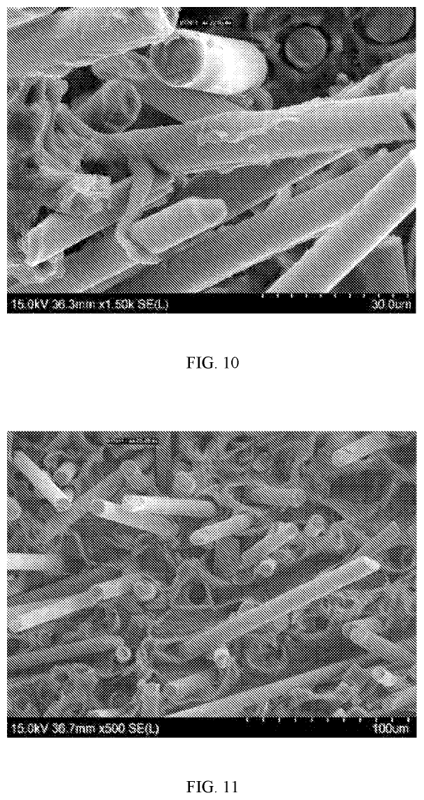

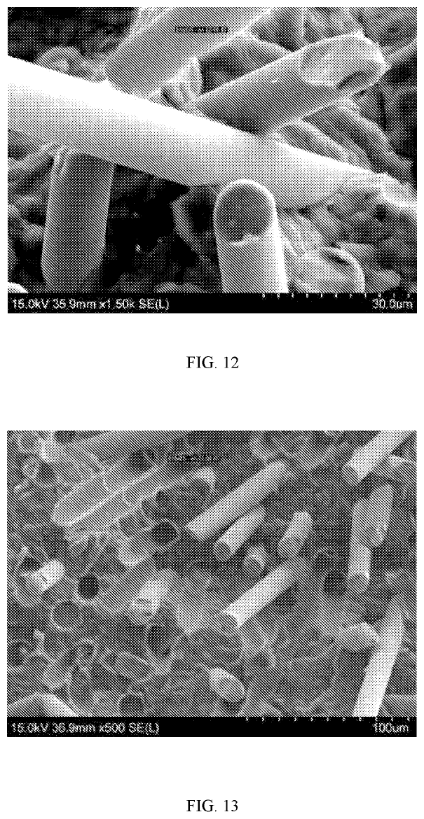

Referring now to FIGS. 8-13, the glass fibers including the polyamide sizing composition shown in FIGS. 8 and 9 resulted in better bonding of the glass fibers than the glass fibers including a polyethylene terephthalate/polybutylene terephthalate sizing composition as shown in FIGS. 10 and 11 and the glass fibers including a polypropylene sizing composition as shown in FIGS. 12 and 13. As shown in FIGS. 8 and 9, the glass fiber fragments have residue polymer on their surface, indicating a better bond between the polyamide sized glass and the polyketone component. Furthermore, FIGS. 10-13 do not show residue polymer on the surface of the glass fibers, indicating little bonding between the glass fibers and the polymer matrix.

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. Although some aspects of the present disclosure are identified herein as preferred or particularly advantageous, it is contemplated that the present disclosure is not necessarily limited to these aspects.

1. A continuous fiber reinforced tape, comprising, based on a total weight of the continuous fiber reinforced tape:
20 wt % to 50 wt % of a polyketone component; and
50 wt % to 80 wt % of a plurality of unidirectional continuous fibers embedded in the polyketone component.

2. (canceled)

3. The continuous fiber reinforced tape of claim 1, wherein the plurality of unidirectional continuous fibers comprise at least one of glass fibers, aramid fibers, basalt fibers, and carbon fibers.

4. The continuous fiber reinforced tape of claim 1, wherein the plurality of unidirectional continuous fibers have an average diameter from 10 μm to 30 μm.

5. The continuous fiber reinforced tape of claim 4, wherein the plurality of unidirectional continuous fibers have an average diameter from 13 μm to 17 μm.

6. The continuous fiber reinforced tape of claim 1, wherein the plurality of unidirectional continuous fibers have an average linear mass density from 4400 TEX to 276 TEX.

7. The continuous fiber reinforced tape of claim 1, wherein the plurality of unidirectional continuous fibers are in a tow, yarn, end, pic, or roving.

8. The continuous fiber reinforced tape of claim 1, wherein the plurality of unidirectional continuous fibers are continuous glass fibers.

9. The continuous fiber reinforced tape of claim 1, wherein the plurality of unidirectional continuous fibers comprises a sizing composition, the sizing composition comprising a polyamide.

10. (canceled)

11. The continuous fiber reinforced tape of claim 1, wherein the polyketone component comprises a polyketone polymer, the polyketone polymer comprising at least 50 wt % polyketone monomer units, based on total weight of the polyketone polymer.

12. The continuous fiber reinforced tape of claim 1, wherein the polyketone component comprises a polyketone polymer, the polyketone polymer comprising less than or equal to 15 wt % of propylene monomer units, based upon the total weight of the polyketone polymer.

13. The continuous fiber reinforced tape of claim 1, wherein the polyketone component comprises a heat stabilizer.

14. (canceled)

15. The continuous fiber reinforced tape of claim 1, wherein the continuous fiber reinforced tape has a length, a width, and a thickness, the thickness being from 0.010 cm to 0.125 cm.

16. The continuous fiber reinforced tape of claim 1, wherein the continuous fiber reinforced tape has a percent weight change after 1000 hrs of water immersion of less than 1.5 wt %.

17. The continuous fiber reinforced tape of claim 1, wherein the continuous fiber reinforced tape is a layer in a laminate.

18. A fiber reinforced pipe comprising:
an interior pipe having an interior cavity and an exterior surface; and
the continuous fiber reinforced tape of claim 1;
wherein the continuous fiber reinforced tape is wrapped around the exterior surface of the interior pipe.

19. The fiber reinforced pipe of claim 18, wherein the continuous fiber reinforced tape is helically wrapped.

20. A fiber reinforced pipe comprising:
an interior cylindrical liner having an interior cavity and an exterior surface;
an exterior cylindrical jacket having an interior cavity and an exterior surface; and
the continuous fiber reinforced tape of claim 1;
wherein the continuous fiber reinforced tape is positioned between the interior cylindrical liner and the exterior cylindrical jacket.

21. The fiber reinforced pipe of claim 20, wherein the continuous fiber reinforced tape is helically wrapped around the exterior surface of the interior cylindrical liner.

22. The fiber reinforced pipe of claim 20, wherein the fiber reinforced pipe is flexible.

23. The fiber reinforced pipe of claim 20, wherein the continuous fiber reinforced tape is a first continuous fiber reinforced tape, and the fiber reinforced pipe further includes a second continuous fiber reinforced tape helically wrapped around the first continuous fiber reinforced tape.

24. (canceled)

25. (canceled)
